(19) United States
(12) Patent Application Publication
(10) Pub. No.: US 2022/0400074 A1
(43) Pub. Date: Dec. 15, 2022

(54) SYSTEM TO TRANSMIT MESSAGES USING MULTIPLE NETWORK PATHS

(71) Applicant: Microsoft Technology Licensing, LLC, Redmond, WA (US)

(72) Inventors: Arvind SRINIVASAN, San Jose, CA (US); Nisheeth SRIVASTAVA, Sammamish, WA (US)

(21) Appl. No.: 17/343,405

(22) Filed: Jun. 9, 2021

(51) Int. Cl. H04L 12/707; H04L 12/721; H04L 12/725

(52) U.S. Cl. CPC H04L 45/24; H04L 45/14; H04L 45/123; H04L 45/306

(57) ABSTRACT

A system includes reception of an instruction to send a message to a computer server, determination of a plurality of segments of the message, determination, for each of the plurality of segments, of a network path from a plurality of network paths to the computer server based on performance-related characteristics of the plurality of network paths, and assignment, for each of the plurality of segments, of the segment to a transmission queue associated with the network path determined for the segment.

### BACKGROUND

Traditional computing systems are connected to an external network via a single network device such as a wired or wireless Network Interface Card (NIC). Some systems may include a secondary NIC to provide failover functionality in case issues arise with the primary NIC. In either case, network traffic to and from the computing system is carried by one network device at any given time.

New topologies allow applications to transmit messages over multiple network devices. For example, an application may execute on a computer server including two network devices. The application may establish two connections with a remote application and tie each connection to a respective network device, each of which represents a different network path. The application then transmits messages associated with a first connection over the respective network device of the first connection and transmits messages associated with a second connection over the respective network device of the second connection. The bandwidth desired for the application may be apportioned between each of the network paths. Each network device may therefore operate at a lower bandwidth than would otherwise be used, providing improved network resiliency and scalability.

These topologies require applications to load-balance messages across multiple network paths. Moreover, a failure of a network device will halt the transmission of messages of the application-to-application connection which is associated with the failed network device.

Systems are desired to transparently leverage all available network paths. Such systems may be used to maximize the network bandwidth which is effectively available to an application connection. Such systems may increase resilience against failures of one or more available network paths. From an application standpoint, it would be beneficial to transmit and receive data over an application-to-application connection without regard to or knowledge of the multiple underlying network paths over which the data may pass.

### BRIEF DESCRIPTION OF THE DRAWINGS

FIG. 1 is a block diagram illustrating transmission of application messages over multiple network paths according to some embodiments.

FIG. 2 is a flow diagram of a process to schedule transmission of a message using multiple network paths according to some embodiments.

FIG. 3 is a block diagram of functional elements of a multipathing component to schedule work queue elements (WQEs) on network paths according to some embodiments.

FIG. 4 illustrates monitoring of network path characteristics and use of the network path characteristics to schedule WQEs on network paths according to some embodiments.

FIG. 5 is a block diagram illustrating transmission of application messages over multiple network paths from both ends of an application connection according to some embodiments.

FIG. 6 is a block diagram illustrating transmission of application messages over multiple network paths according to some embodiments.

FIG. 7 is a block diagram of a datacenter architecture according to some embodiments.

### DETAILED DESCRIPTION

The following description is provided to enable any person in the art to make and use the described embodiments. Various modifications, however, will be apparent to those in the art.

Some embodiments provide an intermediate layer to shield applications from an underlying multi-path fabric implementation. Transparent to an application, data transmitted by the application to a remote application is not tied to a single network path and may travel over multiple network paths. In some embodiments, the intermediate layer segments a message into portions, and, for each portion, the intermediate layer dynamically selects one of several available network paths on which to schedule transmission of the portion. The selection may be based on respective monitored characteristics of the available network paths, including but not limited to a current status (e.g., enabled, disabled, online, offline), queue size, congestion, and performance.

Embodiments may respond seamlessly to NIC failures. For example, a case is considered in which four network paths are available for scheduling transmission of portions of a message, and one of the network paths fails. This failure will be reflected in the monitored characteristics of failed network path, and future message portions will therefore not be scheduled on the failed network path. Any message portions which were previously scheduled on the failed network path and were not successfully received are re-scheduled onto one of the available network paths. Embodiments may therefore improve failure tolerance without requiring action from the sending application or significantly impacting performance.

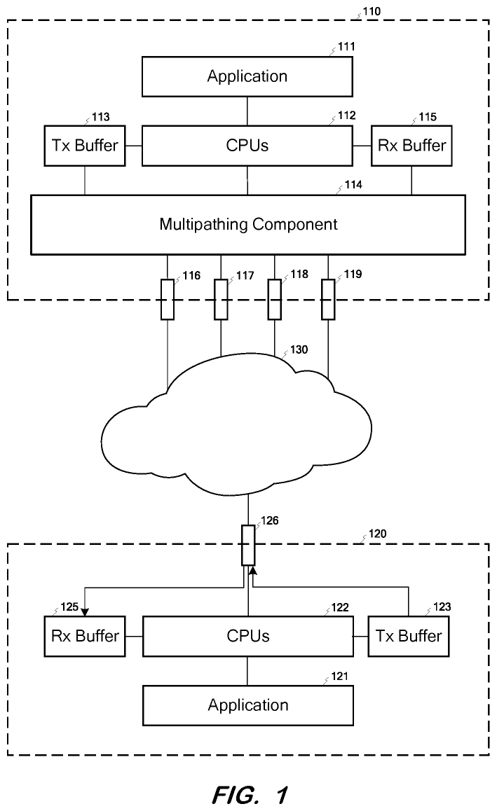

FIG. 1 illustrates multi-path transmission according to some embodiments. Computing system 110 may comprise any computing device comprising one or more Central Processing Units (CPUs) 112, random access memory including transmit buffer 113 and receive buffer 115, and related hardware (e.g., chipset, Graphics Processing Unit, Solid State Drives, cooling devices). The hardware components of computing system 110 provide an environment for the execution of software application 111, which comprises processor-executable program code. An operating system upon which application 111 is executed is omitted from FIG. 1 for clarity, as are associated device drivers. Computing system 110 may comprise a blade server or a rack server installed within a server rack located in a datacenter, but embodiments are not limited thereto.

Computing system 110 also includes NICs 116 through 119. Embodiments of computing system 110 are not limited to any particular number of network devices. As shown, multipathing component 114 logically resides between CPUs 112 and NICs 116 through 119. In some embodiments, one or more hardware accelerators such as a Network Processing Unit may be substituted for CPUs 112 in FIG. 1. Multipathing component 114 may be implemented in processor-executable program code (e.g., within a NIC device driver), hardware (e.g., NIC hardware), or a combination thereof.

Generally, multipathing component 114 receives an instruction from CPUs 112 (or, alternatively, NPUs) to transmit a message over an application connection. The application connection defines a remote application to which the message should be sent. Notably, the received instruction does not specify any particular network path or paths over which the message should be sent.

Multipathing component 114 segments the message into multiple WQEs as will be described below. Also, as will be described below, multipathing component 114 monitors characteristics of network paths which include NICs 116 through 119 and schedules the WQEs on the network paths according to the characteristics.

NICs 116 through 119 may comprise remote direct memory access (RDMA)-enabled NICS (RNICs) but embodiments are not limited thereto. RDMA is a communication protocol which moves data from the memory of one computing system directly into the memory of another computing system with minimal involvement from their respective CPUs. The RDMA protocol allows a computing system to place data directly into its final memory destination in another computing system without additional or interim data copies.

Accordingly, in some embodiments, CPUs 112 may simply use RDMA verbs as is known in the art to instruct multipathing component 114 to transmit messages, with multipathing component 114 appearing as a single RNIC to CPUs 112. Multipathing component 114 receives these RDMA verbs and operates in response as described herein to segment and transmit the messages via NICs 116 through 119.

Network 130 may comprise any number and type of public and private networks suitable to support communication from NICs 116 through 119 to computing system 120 via a desired protocol. Network 130 may comprise a cabled Ethernet network within a datacenter, the public cloud, or any combination thereof, for example.

Computing system 120 may comprise any computing device executing an application 121 to which application 111 wishes to transmit a message. Similarly to computing system 110, computing system 120 comprises one or more CPUs 122, random access memory including transmit buffer 123 and receive buffer 125, and related unshown hardware to provide an environment for the execution of application 121. Computing system 120 may comprise a blade server or a rack server installed within a server rack located in the same datacenter as computing system 110, but embodiments are not limited thereto.

Computing system 120 include NIC 126. According to some embodiments, NIC 126 comprises an RNIC to which CPUs 122 (or one or more corresponding accelerators of computing system 120) directly communicate. Computing system 120 therefore does not include a multipathing component and all network traffic is transmitted from and received at NIC 126. In view of NICs 116 through 119 of computing system 110 and NIC 126 of computing system 120, four network paths exist between computing system 110 and computing system 120 (i.e., NIC 116 to NIC 126, NIC 117 to NIC 126, NIC 118 to NIC 126, and NIC 119 to NIC 126). These four network paths are visible to multipathing component 114 but not to either of application 111 or application 121, although messages sent from application 111 to application 121 may travel over all four network paths as described herein.

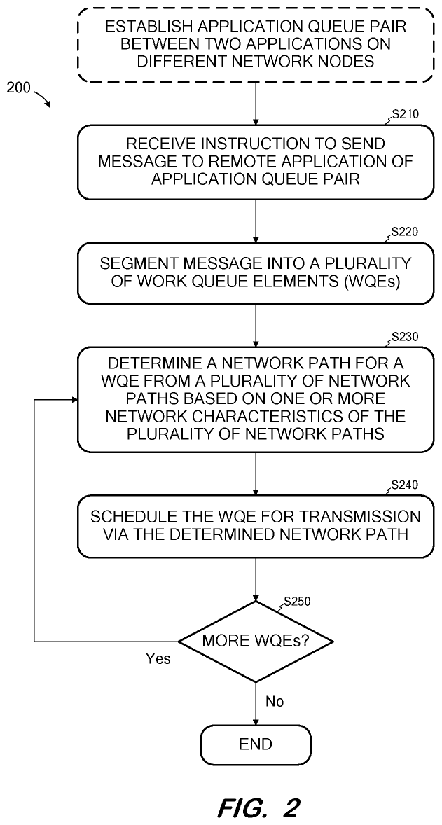

FIG. 2 is a flow diagram of process 200 to schedule transmission of a message using multiple network paths according to some embodiments. Process 200 may be executed by a multipathing component which, as described above, may comprise processor-executable program code and/or hardware.

Prior to S210, a communication channel, or connection, is established between two applications executing on two different network nodes. Computing systems 110 and 120 are examples of network nodes according to some embodiments. Establishment of a communication channel may typically be performed by the two endpoint applications, rather than by a multipath component as described herein, and therefore is depicted in FIG. 2 using a dashed line. The application-to-application communication channel will be referred to herein as an application queue path (AQP).

An AQP may be negotiated between two applications as is known in the art. For example, the sender application may establish the AQP by exchanging control messages with the receiver application based on physical end node addressing (e.g., IP address, MAC address), ordering policy, QoS, etc. The AQP may be assigned specific characteristics such as endpoint characteristics (e.g., in-order, relaxed-order, QoS priority) and network fabric characteristics (e.g., QoS priority, Traffic Class (TC) assignment).

At S210, an instruction is received to send a message to the remote application of the AQP. According to some embodiments, multipath component 114 receives an RDMA instruction from CPUs 112 including a pointer to transmit buffer 113 (which identifies the data of the message) and an identifier of an AQP.

The message is segmented into a plurality of segment, or WQEs, at S220. According to some embodiments, each AQP is associated with a dedicated WQE dispatcher which segments messages associated with the AQP at S220. Using such dedicated WQE dispatchers, each AQP progresses independently and is non-blocking to any other AQPs.

Each WQE includes N packets, where the maximum size of each packet is the maximum transmission unit (MTU) size of the Internet Protocol transport media. The AQP applications may negotiate N prior to segmentation of each new message to be transmitted. At S230, a network path is determined for a WQE based on one or more network characteristics of a plurality of network paths. The plurality of network paths may be determined by a multi-path component according to some embodiments. Determination of the plurality of network paths may be facilitated by node pre-registration and/or a node discovery mechanism.

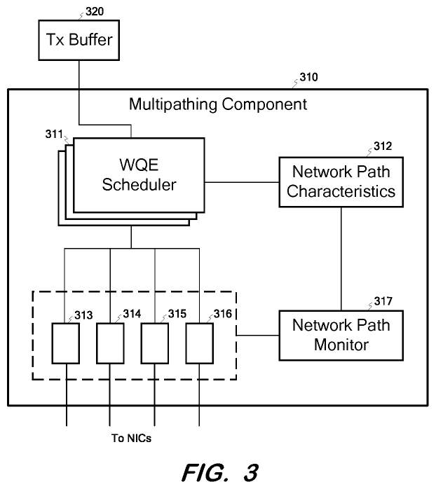

FIG. 3 is a block diagram of functional elements of multipathing component 310 according to some embodiments. Multipathing component 310 includes WQE schedulers 311, each of which may be associated with a respective AQP as described above. At S220, and for a given message associated with a given AQP and residing in application transmit buffer 320, a corresponding WQE scheduler 311 segments the message into WQEs consisting of N packets each. Segmentation may comprise determining offsets of transmit buffer 320 corresponding to each WQE.

Multipathing component 310 also shows queues 313 through 316 to which WQEs may be scheduled at S230. In the illustrated example, each of queues 313 through 316 is associated with a respective network path. If the receiving node includes one NIC, the number of available network paths (and queues) may be equal to the number of NICs of the transmitting node. If the receiving node and the transmitting node each include multiple NICs, the number of available network paths (and queues) may be equal to the product of the number of NICs of the transmitting node and the number of NICs of the receiving node. This calculation is based on the realization that each NIC of the transmitting node may form a network path with each NIC of the receiving node.

A WQE scheduler 311 may determine a network path on which to schedule a WQE at S230 based on network path characteristics 312. Generally, network path monitor 317 may periodically collect performance-related information from each network path and compile the performance-related information into network path characteristics 312. Network path characteristics 312 may specify congestion state, traffic pacing requirements, node reachability, round-trip time (RTT), etc. According to some embodiments, network path monitor 317 updates network path characteristics 312 each time an acknowledgement packet is received from a remote receiver node of a given network path.

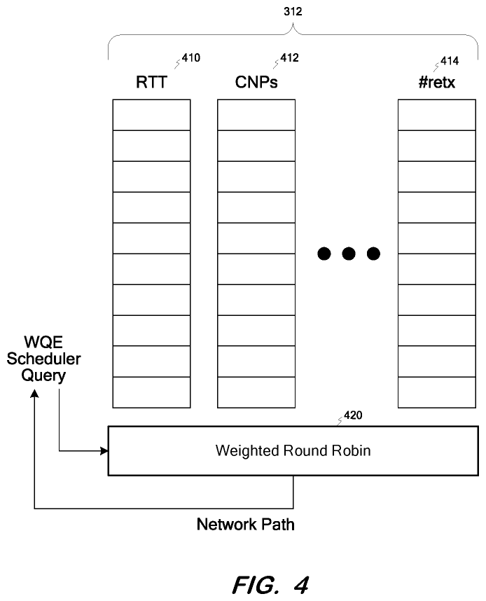

In some embodiments, a WQE scheduler 311 determines a network path based on a weighted round-robin evaluation of network path characteristics 312. FIG. 4 is a block diagram illustrating such a determination according to some embodiments. In the illustrated example, network path characteristics 312 includes sorted lists for each of several characteristics. For example, list 410 sorts network paths based on RTT, list 412 sorts network paths based on congestion notification packets (CNPs) 412 and list 414 sorts network paths based on number of retransmissions (#retx) 414, with the best-performing network path according to a particular metric appearing at the bottom of the list associated with the particular metric.

The lists may be updated and re-sorted in response to each received acknowledgement packet. In some embodiments, a “keep alive” ping is periodically sent over each network path and the RTT for each path is updated based on the response to the ping. In a case that a network path goes down, its RTT would become infinite and cause the network path to jump to the top of sorted list 410.

According to some embodiments of S230, weighted round-robin component 420 receives a query from a WQE scheduler, inputs the lower-most network path of each sorted list to a weighted round-robin function, and returns a network path output by the function to the WQE scheduler. In some embodiments, the network path for a WQE is determined at S230 by randomly selecting a network path from the available network paths.

Use of network path characteristics at S230 may facilitate removal of a network path from usage, for example to apply updates or conduct other maintenance. Specifically, network path monitor 317 may ensure that the network path to be removed is associated with network path characteristics 312 indicating poor performance, regardless of actual performance-related information received from the network path to be removed. Consequently, the network path will not be determined for scheduling a WQE at S230 and can be subjected to maintenance without jeopardizing message delivery.

Determination of a network path at S230 may be based on any suitable factors. In some embodiments, each network path is limited to a certain number (e.g., the Bandwidth Delay Product (BDP) of the network) of outstanding (i.e., assigned but not yet sent) WQEs. Network paths which include this number of outstanding WQEs are not considered in the determination at S230. Determination of a network path at S230 may also ensure that the number of packets to be transmitted does not exceed a rate limiting policy associated with the AQP.

After a network path has been determined for a WQE at S230, the WQE is scheduled for transmission via the determined network path at S240. Scheduling the WQE at S240 may comprise adding the WQE to a transmission queue associated with the network path, such as queues 313-316. At S250, it is determined whether any WQEs of the message remain to be scheduled to a network path. If so, flow returns to S230 and continues as described above. If not, process 200 terminates.

Scheduling of a WQE at S240 may be independent of the scheduling of any other WQEs of the message. This independence may result in later-scheduled WQEs being transmitted before earlier-scheduled WQEs. However, each packet of each WQE will be transmitted in order, relative to the other packets of the WQE.

If transmission of a WQE does not complete within a timeout period, or a nack is received indicating a packet is missing, the multipathing component will schedule the WQE or selected packets thereof for retransmission. If N=1 or another small number, the WQE includes few packets and may simply be scheduled for retransmission on the same network path. If N is greater than the bandwidth delay product (BDP) of the intervening network, lost packets may be individually identified and scheduled for retransmission (also on the same network path), rather than scheduling retransmission of the entire WQE.

At the receiver node (e.g., computing system 120), every received WQE will be processed without regard to order, while packets within a WQE are marked for completion in order. As described above, the message may be associated with an AQP using a field in the protocol header of the message. A memory buffer (e.g., buffer 125) is allocated on the receiver node for a given message based on control messages. For each received WQE, the start address of the buffer is known based on the WQE number. Within a received WQE, the receiver checks if packets arrived in order and places the WQE at the appropriate location in the memory buffer based on the WQE start address, WQE number and MTU.

In some implementations, the receiver node is not configured to place received WQEs directly into appropriate locations of a memory buffer. Such receivers may simply reorder received WQEs in sequence and store the reordered WQEs. In either case, the receiver node may determine whether any WQEs are missing and respond to the sender node accordingly.

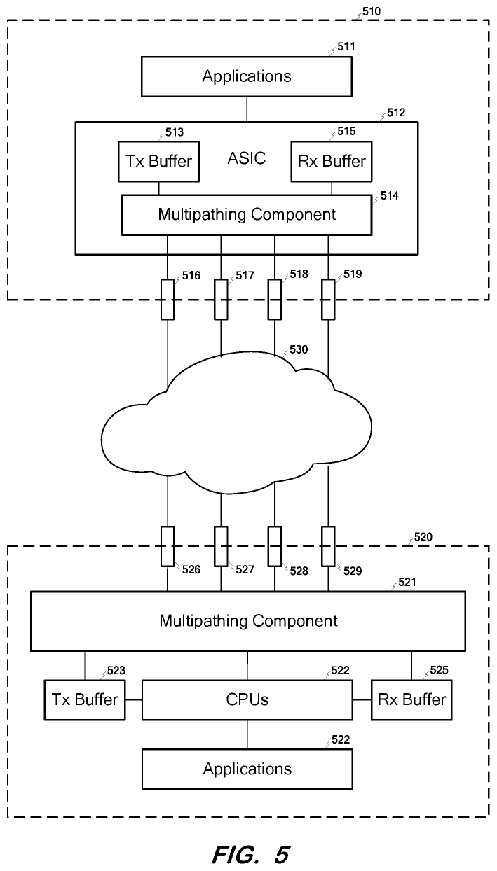

FIG. 5 is a block diagram including computing system 510 and computing system 520. Computing system 520 may be implemented as described with respect to computing system 110. Computing system 510, on the other hand, implements transmit buffer 513, multipathing component 514 and receive buffer 515 within a single application-specific integrated circuit (ASIC) 512. Computing system 520 may be similarly-implemented in some embodiments.

Embodiments are not limited to four NICs or to equal numbers of NICs on either side of an AQP. Sixteen network paths exist between computing system 510 and computing system 520. Specifically, network paths are defined by NIC 516/NIC 526, NIC 516/NIC 527, NIC 516/NIC 528, NIC 516/NIC 529, NIC 517/NIC 526, NIC 517/NIC 527, NIC 517/NIC 528, NIC 517/NIC 529, NIC 518/NIC 526, NIC 518/NIC 527, NIC 518/NIC 528, NIC 518/NIC 529, NIC 519/NIC 526, NIC 519/NIC 527, NIC 519/NIC 528, and NIC 519/NIC 529. Any number of network paths may exist between two networks nodes according to some embodiments,

Either of multipathing component 514 and multipathing component 521 may operate as described above with respect to process 200 to transmit a message associated with an AQP over any combination of the sixteen network paths. Received WQEs are placed directly into receive buffers 515 and 525 as described above.

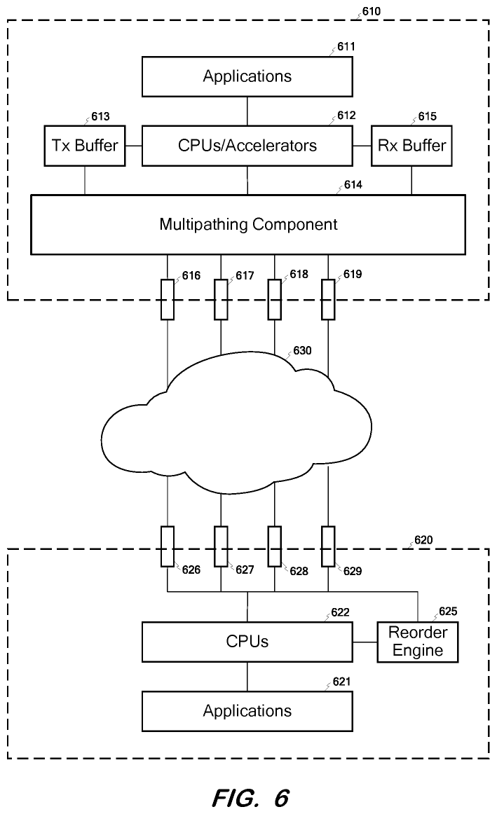

FIG. 6 is a block diagram including computing system 610 and computing system 620. Computing system 610 may be implemented as described with respect to computing system 110. Computing system 620 includes four NICs 626-629 which, in conjunction with NICs 616-619 of computing system 610, define sixteen network paths between computing system 610 and computing system 620.

Multipathing component 614 of computing system 610 may operate as described above with respect to process 200. Computing system 620 may transmit messages over NICs 626-629, where each application-to-application connection is tied to one specific NIC. Computing system 620 includes reorder engine 625 for receiving WQEs transmitted by multipathing component 614, reordering the WQEs, and storing the reordered WQEs. Reorder engine 625 may also identify missing WQEs and instruct CPUs 622 to request retransmission thereof.

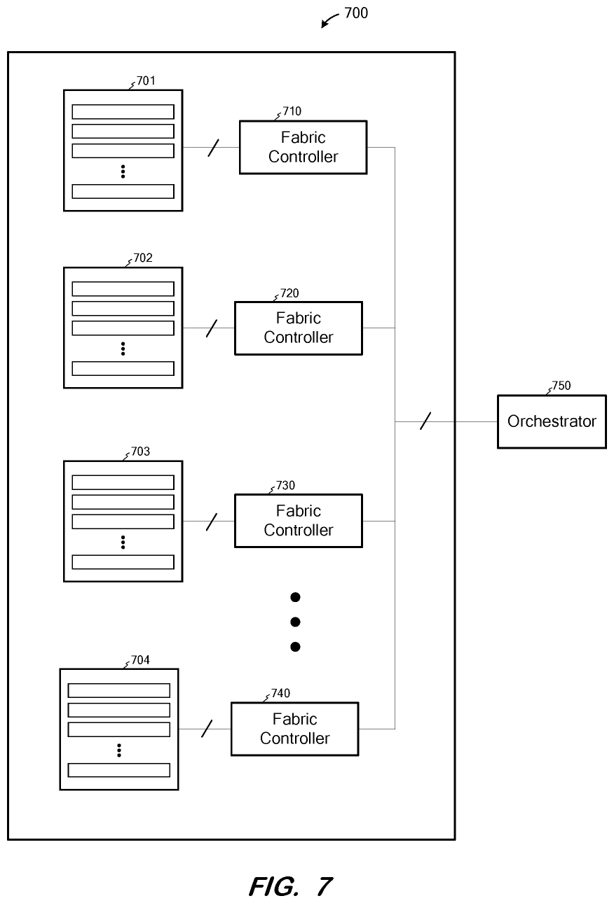

FIG. 7 illustrates datacenter 700 according to some embodiments. Datacenter 700 includes server racks 701-704, each of which is associated with a dedicated fabric controller 710-740. Orchestrator 750 communicates with fabric controllers 710-740, and a given fabric controller 710-740 communicates with each server mounted within an associated server rack 701-704. The number of servers per rack need not be identical.

Any number of servers of datacenter 700 may implement any of the computing systems described herein. For example, a server of datacenter 700 may implement computing system 110 to transmit messages of a given AQP over multiple network paths to another server of datacenter 700. Any server of datacenter 700 may also transmit messages of a given AQP over multiple network paths to another server which is not located within datacenter 700.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions.

All processes mentioned herein may be embodied in processor-executable program code read from one or more of non-transitory computer-readable media, such as ROM, RAM, a hard disk drive, a solid-state drive, and a flash drive, and then stored in a compressed, uncompiled and/or encrypted format. such program code may be executed by one or more processors such as but not limited to a microprocessor, a microcontroller, and a processor core. In some embodiments, hard-wired circuitry may be used in place of, or in combination with, program code for implementation of processes according to some embodiments. Embodiments are therefore not limited to any specific combination of hardware and software.

Embodiments described herein are solely for the purpose of illustration. Those in the art will recognize other embodiments may be practiced with modifications and alterations to that described above.

1. A computer server comprising:
a plurality of network interface cards, each of the plurality of network interface cards associated with one or more network paths to a second computer server; and
a component to receive an instruction to send a message to the second computer server and, in response to the instruction, to:
determine a plurality of segments of the message;
maintaining a plurality of sorted lists, each of the plurality of sorted lists including, for each of the one or more network paths associated with each one of the plurality of network interface cards, a value of a respective performance-related characteristic;
for each of the plurality of segments, determine a network path based on the sorted lists; and
for each of the plurality of segments, schedule the segment for transmission via the network path determined for the segment.

2. A system according to claim 1, further comprising:
a transmit buffer,
wherein the instruction comprises a pointer to the message in the transmit buffer, and
wherein the message is associated with a first application executing on the computer server and a second application executing on the second computer server.

3. A system according to claim 2,
wherein each of the plurality of network interface cards is a remote direct memory access-enabled network interface card.

4. A system according to claim 1,
wherein the component is to receive a second instruction to send a second message and, in response to the second instruction, to:
determine a second plurality of segments of the second message;
for each of the second plurality of segments, determine a network path based on the sorted lists; and
for each of the second plurality of segments, schedule the segment for transmission via the network path determined for the segment.

5. A system according to claim 4,
wherein the message is associated with a first application pair comprising a first application executing on the computer server and a second application executing on the second computer server,
wherein the second message is associated with a second application pair comprising the first application executing on the computer server and a third application executing on the second computer server,
wherein the plurality of segments and network paths for each of the plurality of segments are determined by a first dispatcher associated with the first application pair, and
wherein the second plurality of segments and network paths for each of the second plurality of segments are determined by a second dispatcher associated with the second application pair.

6. A system according to claim 1, wherein the performance-related characteristics of a network path are updated in response to reception of an acknowledgement packet on the network path.

7. A system according to claim 1, wherein the one or more network paths associated with each of the plurality of network interface cards comprise network paths from each of the plurality of network interface cards of the computer server to each of a plurality of network interface cards of the second computer server.

8. A method for a computer server, comprising:
receiving an instruction to send a message to a second computer server;
determining a plurality of segments of the message;
maintaining a plurality of sorted lists, each of the plurality of sorted lists including, for each one of a plurality of network paths from the computer server to the second computer server, a value of a respective performance-related characteristic;
for each of the plurality of segments, determining a network path from the plurality of network paths from the computer server to the second computer server based on the sorted lists; and
for each of the plurality of segments, assigning the segment to a transmission queue associated with the network path determined for the segment.

9. A method according to claim 8, wherein the message is associated with an application pair including a first application executing on the computer server and a second application executing on the second computer server, and
wherein the instruction comprises a pointer to the message in a transmit buffer and an identifier of the application pair.

10. A method according to claim 8, further comprising:
receiving an instruction to send a second message to a third computer server;
determining a second plurality of segments of the second message;
for each of the second plurality of segments, determining a network path from a second plurality of network paths from the computer server to the third computer server based on the sorted lists; and
for each of the second plurality of segments, assigning the segment to a transmission queue associated with the network path determined for the segment of the second plurality of segments.

11. A method according to claim 10,
wherein the message is associated with a first application pair comprising a first application executing on the computer server and a second application executing on the second computer server,
wherein the second message is associated with a second application pair comprising the first application executing on the computer server and a third application executing on the third computer server,
wherein the plurality of segments and network paths for each of the plurality of segments are determined by a first dispatcher associated with the first application pair, and
wherein the second plurality of segments and network paths for each of the second plurality of segments are determined by a second dispatcher associated with the second application pair.

12. A method according to claim 8, further comprising updating performance-related characteristics of a network path in response to reception of an acknowledgement packet on the network path.

13. A method according to claim 8, wherein the plurality of network paths comprise network paths from each of a plurality of network interface cards of the computer server to each of a plurality of network interface cards of the second computer server.

14. A non-transitory medium storing program code executable by a processor to cause a computer server to:
receive an instruction to send a message to a second computer server;
determine a plurality of segments of the message;
maintaining a plurality of sorted lists, each of the plurality of sorted lists including, for each one of a plurality of network paths from the computer server to the second computer server, a value of a respective performance-related characteristic;
for each of the plurality of segments, determine a network path from the plurality of network paths from the computer server to the second computer server based on the sorted lists; and
for each of the plurality of segments, assign the segment to a transmission queue associated with the network path determined for the segment.

15. A medium according to claim 14, wherein the message is associated with an application pair including a first application executing on the computer server and a second application executing on the second computer server, and
wherein the instruction comprises a pointer to the message in a transmit buffer and an identifier of the application pair.

16. A medium according to claim 14, the program code executable by a processor to cause a computing system to:
receive an instruction to send a second message to a third computer server;
determine a second plurality of segments of the second message;
for each of the second plurality of segments, determine a network path from a second plurality of network paths from the computer server to the third computer server based on the sorted lists; and
for each of the second plurality of segments, assign the segment to a transmission queue associated with the network path determined for the segment of the second plurality of segments.

17. A medium according to claim 16,
wherein the message is associated with a first application pair comprising a first application executing on the computer server and a second application executing on the second computer server,
wherein the second message is associated with a second application pair comprising the first application executing on the computer server and a third application executing on the third computer server,
wherein the plurality of segments and network paths for each of the plurality of segments are determined by a first dispatcher associated with the first application pair, and
wherein the second plurality of segments and network paths for each of the second plurality of segments are determined by a second dispatcher associated with the second application pair.

18. A medium according to claim 14, the program code executable by a processor to cause a computing system to update performance-related characteristics of a network path in response to reception of an acknowledgement packet on the network path.

19. A medium according to claim 14, wherein the plurality of network paths comprise network paths from each of a plurality of network interface cards of the computer server to each of a plurality of network interface cards of the second computer server.

20. A medium according to claim 19,
wherein each of the plurality of network interface cards is a remote direct memory access-enabled network interface card.
